(19) United States
(12) Patent Application Publication
(10) Pub. No.: US 2026/0106261 A1
(43) Pub. Date: Apr. 16, 2026

(54) COOLING BEAM FOR A BATTERY PACK

(71) Applicant: GM Global Technology Operations LLC, Detroit, MI (US)

(72) Inventors: Lu Huang, Troy, MI (US); Hui-ping Wang, Troy, MI (US); Alexander M. Bilinski, Avoca, MI (US); Phillip Daniel Hamelin, Holly, MI (US); Yunzhi Xu, Ferndale, MI (US); William Yu Chen, Troy, MI (US)

(73) Assignee: GM Global Technology Operations LLC, Detroit, MI (US)

(21) Appl. No.: 18/915,865

(22) Filed: Oct. 15, 2024

(51) Int. Cl. H01M 10/6556; B60L 50/64; H01M 10/613; H01M 10/625; H01M 10/656; H01M 50/209; H01M 50/289

(52) U.S. Cl. CPC H01M 10/6556; B60L 50/64; H01M 10/613; H01M 10/625; H01M 10/656; H01M 50/209; H01M 50/289; H01M 2220/20

(57) ABSTRACT

A cooling beam having a first end and a second end spaced from the first end, and including a center plate extending between the first end and the second end, and a first surface and a second surface opposite the first surface, one or more cooling channels extending between the first end and the second end and coupled to the first surface and the second surface, and a coolant pathway arranged between the center plate and the one or more cooling channels, the coolant pathway configured to carry a fluid between one or more inlets and one or more outlets.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to battery packs for electric vehicles and, more particularly, to cooling beams arranged between one or more battery cells.

Some rechargeable energy storage systems (RESS) can include one or more battery cells and one or more cooling channels arranged between or below the one or more battery cells. Existing RESS can occupy a large footprint and add a considerable amount of weight to a vehicle. Additionally, assembly and packaging these systems can be complex due to the number of components and the large footprint required to package the system in the vehicle. Shortcomings of existing systems are addressed by one or more aspects of the present disclosure.

### SUMMARY

In one configuration, a cooling beam having a first end and a second end spaced from the first end is provided and includes a center plate extending between the first end and the second end, and a first surface and a second surface opposite the first surface. The cooling beam further including one or more cooling channels extending between the first end and the second end and coupled to the first surface and the second surface. The cooling beam further including a coolant pathway arranged between the center plate and the one or more cooling channels, the coolant pathway configured to carry a fluid between one or more inlets and one or more outlets.

The cooling beam may include one or more of the following optional aspects. For example, the center plate can include one or more projections coupled to and extending away from the first surface and the second surface toward the one or more cooling channels.

According to at least one aspect, the cooling channels include an inner surface and an outer surface opposite the inner surface. The inner surface and the outer surface can include dimples that extend toward the center plate.

According to another aspect, the inner surface can include one or more concave portions and the outer surface can include one or more convex portions that correspond with the one or more concave portions. The convex portions can each include a contact region that is substantially parallel to the center plate.

According to at least one example, the center plate includes a first half and a second half coupled to the first half.

According to another example, the cooling beam can further include a first region near the first end and a second region near the second end. The one or more inlets and the one or more outlets can be arranged between the first region and the second region. The cooling pathway can include a first serpentine path that extends along the first region between the one or more inlets and the one or more outlets and a second serpentine path that extends along the second region between the one or more inlets and the one or more outlets.

In another configuration, a battery pack is provided and includes one or more battery cells, the one or more battery cells each including a prismatic can, including a first end and a second end spaced from the first end, a third end and a fourth end spaced from the third end, a first surface extending between the first, second, third, and fourth ends, and a second surface extending between the first, second, third, and fourth ends, and spaced from the first surface. The battery pack further including one or more cooling beams having a first end and a second end, including a center plate having a first surface and a second surface that each extend between the first end and the second end of the one or more cooling beams, the center plate having a first flange at the first end of the one or more cooling beams that extends away from the first surface and the second surface and a second flange at the second end of the one or more cooling beams that extends away from the first surface and the second surface. The one or more cooling beams further including one or more cooling channels coupled to the first surface and the second surface of the center plate.

The battery pack may include one or more of the following optional aspects. For example, the first flange and the second flange can include a notch that is configured to receive a portion of the prismatic can.

According to at least one aspect, the first flange can contact the third end of one of the prismatic cans and the second flange can contact the fourth end of the same prismatic can.

According to another aspect, the first flange can include a first lip that depends from the first flange toward the second end of one of the one or more cooling beams and the second flange can include a second lip that depends from the second flange toward the first end of one of the one or more cooling beams. The first lip and the second lip can each contact a portion of the one or more battery cells.

In another configuration, a vehicle is provided and includes a vehicle body, a motor coupled to the vehicle body, and a battery pack coupled to the vehicle body and communicatively coupled to the motor. The battery pack including one or more battery cells each having a prismatic can and one or more cooling beams each having a first end and a second end spaced from the first end. The one or more cooling beams being arranged between the one or more battery cells and the one or more cooling beams including a center plate having a first surface and a second surface that each extend between the first end of the one or more cooling beams and the second end of the one or more cooling beams, the center plate having a first flange at the first end that extends away from the first surface and the second surface and a second flange at the second end that extends away from the first surface and the second surface. The one or more cooling beams further including one or more cooling channels coupled to the first surface and the second surface of the center plate.

The vehicle may include one or more of the following optional aspects. For example, the first flange and the second flange can include a notch that is configured to receive a portion of the prismatic can.

According to at least one aspect, the first flange and the second flange can each contact one of the prismatic cans.

According to another aspect, the first flange can include a first lip that depends from the first flange toward the second end of one of the one or more cooling beams and the second flange can include a second lip that depends from the second flange toward the first end of one of the one or more cooling beams. The first lip and the second lip can each contact a portion of the one or more battery cells.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle including a battery pack according to principles of the present disclosure;

FIG. 2 is a side perspective view of a portion of the battery pack of FIG. 1 including one or more battery cells and one or more cooling beams;

FIG. 3 is a side perspective view of one of the one or more cooling beams of FIG. 2;

FIG. 4 is a front view of a configuration of a cooling sheet of the one or more cooling beams of FIG. 2;

FIG. 5 is a front view of another configuration of a cooling sheet of the one or more cooling beams of FIG. 2;

FIG. 6 is a cross-sectional perspective view of the cooling beam of FIG. 3;

FIG. 7 is a partial cross-sectional view of one configuration of the battery pack of FIG. 2;

FIG. 8 is a partial cross-sectional view of another configuration of the battery pack of FIG. 2;

FIG. 9 is a partial cross-sectional view of another configuration of the battery pack of FIG. 2;

FIG. 10 is a partial cross-sectional view of another configuration of the battery pack of FIG. 2;

FIG. 11 is a partial cross-sectional view of another configuration of the battery pack of FIG. 2; and

FIG. 12 is a cross-sectional view of another configuration of a cooling beam according to principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

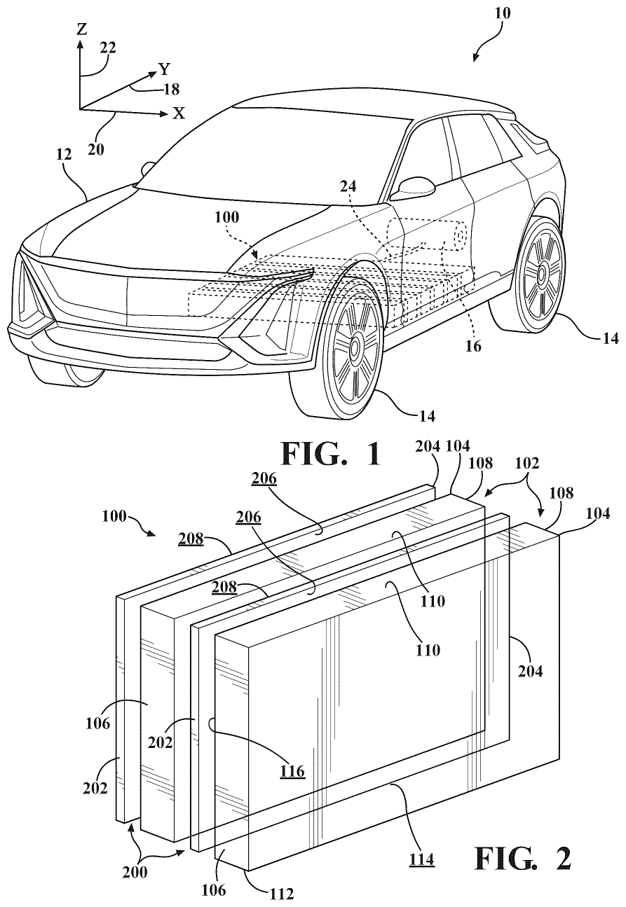

With reference to FIG. 1, a vehicle 10, such as an electric motor vehicle, is provided. The vehicle 10 includes a vehicle body 12, one or more wheels 14, and an electric motor 16 arranged in the vehicle body 12. The vehicle body 12 extends in a first direction (i.e., a fore-aft or longitudinal direction) 18, a second direction (i.e., a cross-car or lateral direction) 20, and a third direction (i.e., a vertical direction) 22. The electric motor 16 may be configured to drive one or more of the one or more wheels 14 to propel the vehicle 10. The vehicle 10 includes a battery pack 100 that can be arranged in the vehicle body 12 and is communicatively coupled to the electric motor 16 via an electric power cable 24.

With reference to FIG. 2, a portion of the battery pack 100 is provided and generally includes one or more battery cells 102 and one or more cooling beams 200 arranged between the one or more battery cells 102. The one or more battery cells 102 and the one or more cooling beams 200 are shown spaced from each other for illustrative purposes. However, in assembly, the one or more battery cells 102 and the one or more cooling beams 200 can be arranged so that the one or more cooling beams 200 can remove heat from the one or more cells 102 during operation and during charging, for example.

With continued reference to FIG. 2, the one or more battery cells 102 can each include a prismatic can 104 that has a first end 106, a second end 108 spaced from the first end 106, a third or upper end 110, and a fourth or lower end 112 spaced from the upper end 110. Additionally, each prismatic can 104 includes a first surface 114 and a second surface 116 spaced from the first surface 114. The first surface 114 and the second surface 116 each extend between the first end 106, the second end 108, the upper end 110, and the lower end 112. According to one aspect, the first surface 114 and the second surface 116 can be the largest surfaces of the prismatic can 104 and can be configured to transmit heat away from the prismatic can 104.

With continued reference to FIG. 2, the one or more cooling beams 200 include a first end 202 and a second end 204 spaced from the first end 202. Additionally, each of the one or more cooling beams include a first cooling surface 206 and a second cooling surface 208 spaced from the first cooling surface that are configured to engage with and/or contact the prismatic can 104.

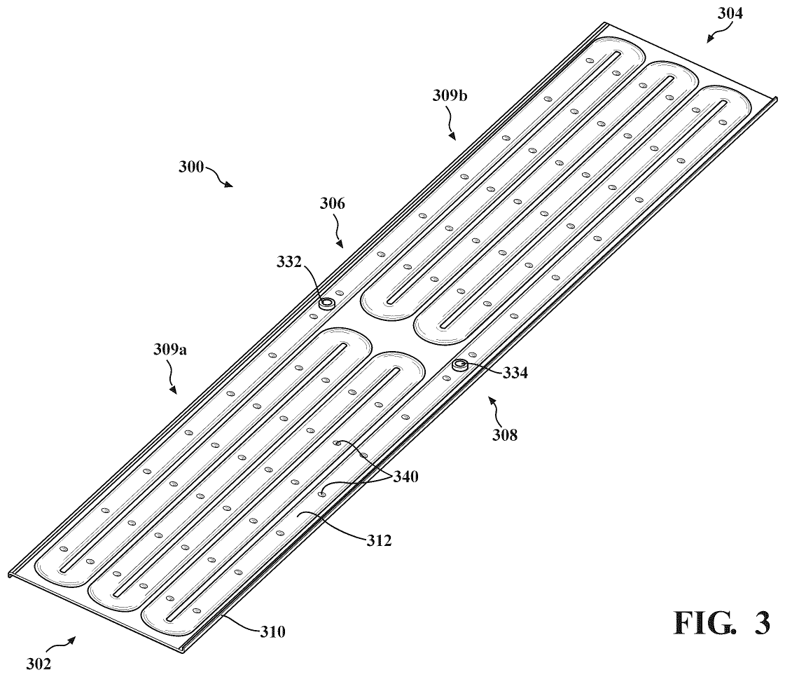

FIGS. 3-7 provide an illustrative configuration of a cooling beam 300. This configuration is similar in many respects to the configuration of FIGS. 1 and 2. Accordingly, the descriptions of the configurations are hereby incorporated into one another, and description of subject matter common to the configurations generally may not be repeated.

With reference to FIG. 3, the cooling beam 300 includes a first end 302, a second end 304 spaced from the first end 302, a third or upper end 306, and a fourth or lower end 308 spaced from the upper end 306. The cooling beam 300 can also include a first region 309a near the first end 302 and a second region 309b near the second end 304. In one configuration, one or more of the battery cells 102 can be arranged adjacent to or with respect to the first region 309a and one or more of the battery cells 102 can be arranged adjacent to or with respect to the second region 309b. The cooling beam 300 can include a center plate 310 and one or more cooling channels (e.g., cooling sheets) 312 coupled to or otherwise attached to the center plate 310.

With continued reference to FIG. 3, the center plate 310 extends between the first end 302 and the second end 304 and between the upper end 306 and the lower end 308. The center plate 310 includes a first surface 314 and a second surface 316 opposite the first surface 314, as shown in FIG. 7. The first and second surfaces 314, 316 can be arranged generally parallel to the first and second surfaces 114, 116 of at least one of the prismatic cans 104 of the one or more battery cells 102. The center plate 310 can be configured to separate the one or more battery cells 102 and provide a thermal barrier that prevents and/or mitigates propagation of a thermal runaway event in the battery pack 100.

With reference to FIG. 7, the center plate 310 can include one or more flanges that can further define the center plate 310 at the first end 302 and/or the second end 304 of the cooling beam 300. For instance, the flanges can include a first flange 318 that is coupled to and extends away from the second surface 316 and a second flange 320 that is coupled to and extends away from the first surface 314. The first and second flanges 318, 320 can be made of the same material as the center plate 310 or a different material than the center plate 310. Additionally, the first flange 318 and/or the second flange 320 can be an integral part of the center plate 310 or separate components that are coupled to or otherwise attached to the center plate 310. The flanges 318, 320 can be desirable to help constrain the cooling beam 300 with respect to the vertical direction 22. The flanges 318, 320 can also be desirable to maintain separation between the one or more battery cells 102 and the center plate 310. In other words, the flanges 318, 320 can help prevent the one or more battery cells 102 from collapsing the one or more cooling channels 312 during installation. While not readily shown in the drawings, the first flange 318 and/or the second flange 320 can be coupled or otherwise attached to a battery tray via welding, adhesive, or using another method. The battery tray can protect the one or more battery cells 102 and the one or more cooling beams 300 from wear or damage due to air, water, etc.

With continued reference to FIG. 7, the center plate 310 is shown including one or more projections 321 coupled to and extending away from the first surface 314 and/or the second surface 316. The projections 321 can be desirable to prevent the cooling channels 312 from collapsing during installation and operation, for example. In other words, the projections 321 can help ensure that there is at least some separation between the center plate 310 and the cooling channels 312 so that fluid can flow therebetween and heat can be removed from the one or more battery cells 102.

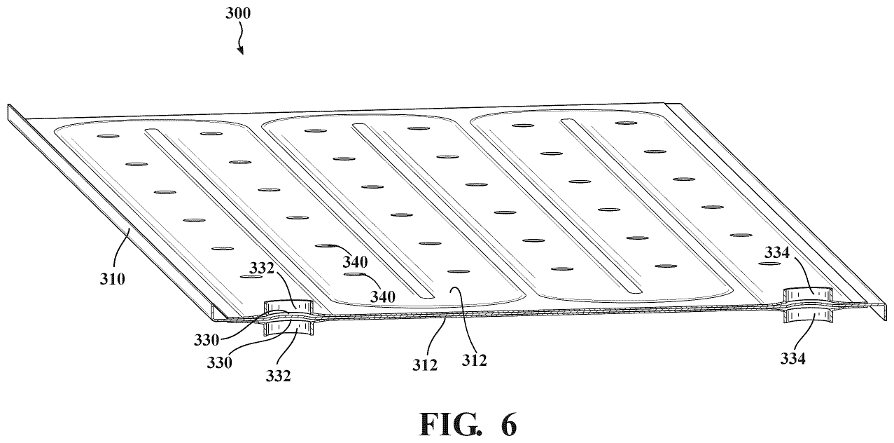

With reference to FIGS. 6 and 7, the one or more cooling channels (i.e., cooling sheets) 312 extend between the first end 302 and the second end 304 and between the upper end 306 and the lower end 308. The cooling channels 312 can be coupled to or otherwise attached to the center plate 310 using fusion welding, heat welding, over-molding, or another joining technique, for example. Each of the cooling channels 312 includes a first or inner surface 322 and a second or outer surface 324 opposite the inner surface 322, as shown in FIG. 7. In the present illustrative configuration, the inner surface 322 of one of the cooling channels 312 faces the first surface 314 and the inner surface 322 of another of the cooling channels 312 faces the second surface 316. Additionally, the inner surface 322 can include one or more concave portions 326 and the outer surface 324 can have one or more convex portions 328 that are opposite the concave portions 326. The convex portions 328 can include a contact region 329 that is configured to engage with a portion of at least one of the one or more battery cells 102. With reference to FIG. 6, a cooling pathway 330 can be arranged between the inner surfaces 322 of the one or more cooling channels 312 and the center plate 310 and is communicatively coupled to one or more inlets 332 and to one or more outlets 334. With reference to FIG. 3 the cooling pathway 330 can extend from the one or more inlets 332 and follow a first serpentine pattern 336 along the first region 309a to the one or more outlets 334. Similarly, the cooling pathway 330 can extend from the one or more inlets 332 and follow a second serpentine pattern 338 along the second region 309b to the one or more outlets 334. In another configuration, the cooling pathway 330 can also be arranged so that the one or more cooling channels 312 are arranged in parallel and extend between the first end 302 or the second end 304 of the cooling beam 300. Arranging the one or more inlets 332 and the one or more outlets 334 between the first region 309a and the second region 309b can be desirable to protect them from side impact load cases. However, in other configurations, the one or more inlets 332 and/or the one or more outlets 334 can be arranged at the first end 302 or the second end 304 of the cooling beam 300.

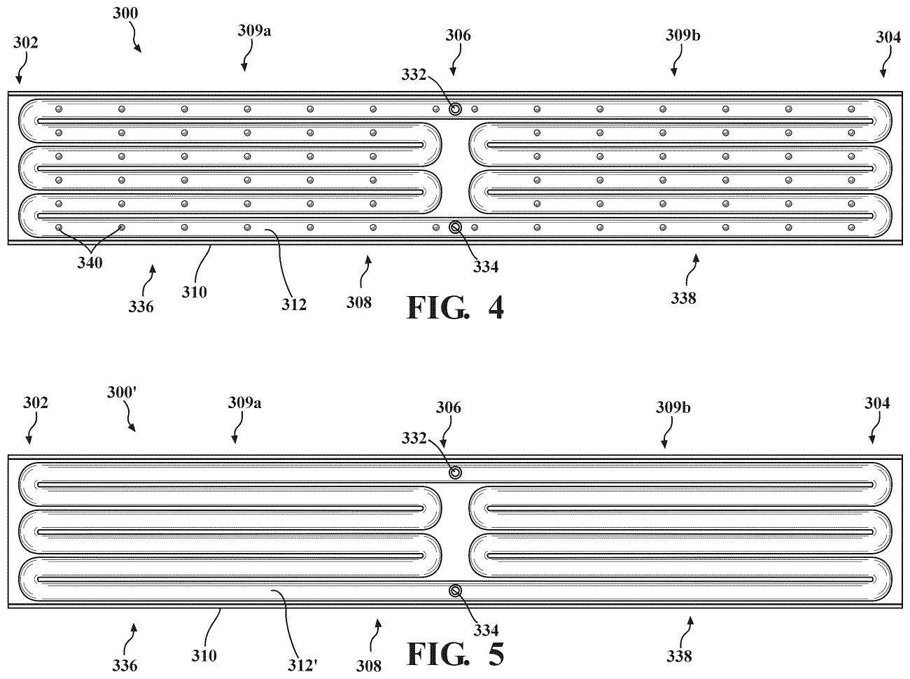

With reference to FIG. 4, the cooling channels 312 can include one or more dimples or embossed features 340 that extend towards the center plate 310 and are arranged along the cooling pathway 330. The one or more dimples 340 can be desirable to prevent the cooling pathway 330 from collapsing. The dimples 340 can correspond with the projections 321 of the center plate 310 or can contact another portion of the center plate 310. According to one aspect, the dimples 340 can induce turbulent flow which can improve cooling efficiency.

In another configuration, with reference to FIG. 5, the cooling channels 312 can be smooth and not include any dimples or embossed features.

The cooling channels 312 can be made of thermally conductive metals, such as composites or polymers. In general, the cooling channels 312 can have a thickness T1 that is less than 1 millimeter (mm). However, the thickness T1 may vary to achieve a certain rigidity and flexibility, for example. The cooling channels 312 typically maintain a shape when a thicker material is used. On the other hand, when using a thin material, the cooling channels 312 can expand when filled with a coolant or another fluid. Selecting a thin material can be desirable to enhance elasticity so that the cooling beam 300 can accommodate the one or more battery cells 102 if they swell during operation or charging, for example. Additionally or alternatively, selecting a thin material may be desirable so that more of the contact region 329 can engage with a surface (e.g., the first surface or the second surface) of the prismatic can 104 and improve cooling efficiency between the one or more battery cells 102 and the one or more cooling beams 300. According to one aspect, the cooling beam 300 can include a thin layer of conductive adhesive to bond the contact region 329 to the prismatic can 104. The use of a conductive adhesive may be desirable so that a thermal interface material (TIM) does not have to be used, for example.

In assembly, one of the one or more battery cells 102 is arranged adjacent to the one of the one or more cooling beams 300. As shown in FIG. 7 the one or more battery cells 102 and can be compressed against the cooling channels 312 of the cooling beams 300 so that the contact regions 329 conform to the first surface 114 and the second surface 116 of the prismatic can 104, for example. Decreasing an air gap between the cooling channels 312 and the prismatic can 104 be desirable to improve cooling efficiency.

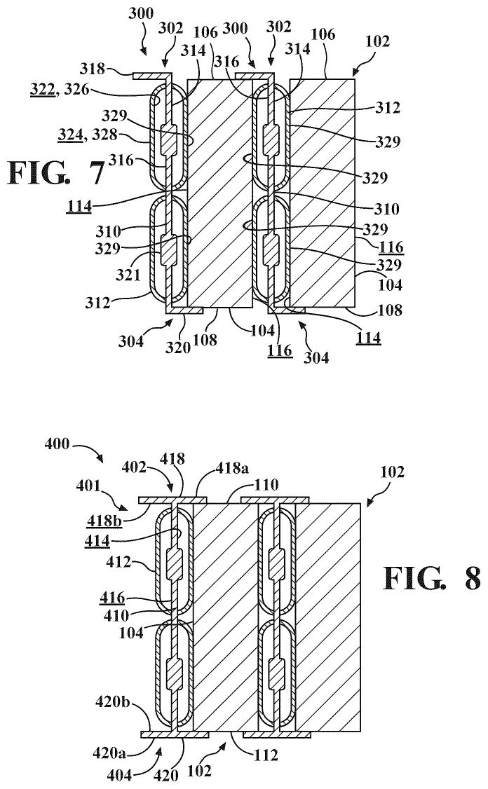

FIGS. 8-11 provide illustrative configurations of several battery packs 400, 500, 600, 700. These configurations are similar in many respects to the configurations of FIGS. 1-2 and FIGS. 3-7. Accordingly, the descriptions of the configurations are hereby incorporated into one another, and description of subject matter common to the configurations generally may not be repeated.

With reference to FIG. 8, the battery pack 400 is provided and includes the one or more battery cells 102 and one or more cooling beams 401. Each cooling beam 401 includes a first end 402 and a second end 404 spaced from the first end 402. Additionally, each cooling beam 401 includes a center plate 410 and one or more cooling channels 412 coupled to the center plate 410. Each center plate 410 has a first surface 414 and a second surface 416 opposite the first surface 414. One or more flanges can be coupled to the center plate 410 at the first end 402 and the second end 404 of each of the cooling beams 401. In the present illustrative configuration, the one or more flanges include a first flange 418 coupled to the center plate 410 at the first end 402 and a second flange 420 coupled to the center plate 410 at the second end 404. The first flange 418 extends away from the first surface 414 and the second surface 416. Likewise, the second flange 420 extends away from the first surface 414 and the second surface 416. The first flange 418 includes a first surface 418a and a second surface 418b and the second flange 420 includes a first surface 420a and a second surface 420b. The second surface 418b of the first flange 418 can be spaced from the second surface 420b of the second flange 420 such that the prismatic can 104 engage with and be arranged between the first flange 418 and the second flange 420. In other words, the second surface 418b can contact the upper end 110 of the prismatic can 104 and the second surface 420b can contact the lower end 112 of the prismatic can 104.

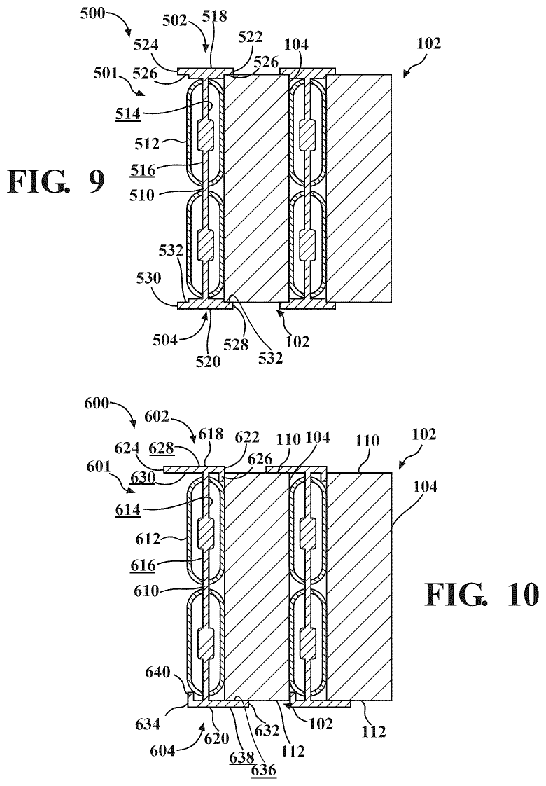

With reference to FIG. 9, the battery pack 500 is provided and includes the one or more battery cells 102 and one or more cooling beams 501. Each cooling beam 501 includes a first end 502 and a second end 504 spaced from the first end 502. Additionally, each cooling beam 501 includes a center plate 510 and one or more cooling channels 512 coupled to the center plate 510. Each center plate 510 has a first surface 514 and a second surface 516 opposite the first surface 514. One or more flanges can be coupled to the center plate 510 at the first end 502 and the second end 504 of each of the cooling beams 501. In the present illustrative configuration, the one or more flanges include a first flange 518 coupled to the center plate 510 at the first end 502 and a second flange 520 coupled to the center plate 510 at the second end 504. The first flange 518 extends away from the first surface 514 to a first end 522 and extends away from the second surface 516 to a second end 524. The first end 522 and the second end 524 of the first flange 518 can each include a notch or stepped portion 526 that is configured to engage with and/or receive a portion of the prismatic can 104. The second flange 520 extends away from the first surface 514 to a first end 528 and extends away from the second surface 516 to a second end 530. The first end 528 and the second end 530 of the second flange 520 can each include a notch or stepped portion 532 that is configured to engage with and/or receive a portion of the prismatic can 104. The stepped portions 526, 532 of the first flange 518 and the second flange 520 can be desirable to prevent the battery cells from deforming or crushing the one or more cooling channels 512. Additionally, the stepped portions 526, 532 of the first flange 518 and the second flange 520 can be desirable to constrain the one or more battery cells 102 between the first flange 518 and the second flange 520.

With reference to FIG. 10, the battery pack 600 is provided and includes the one or more battery cells 102 and one or more cooling beams 601. Each cooling beam 601 includes a first end 602 and a second end 604 spaced from the first end 602. Additionally, each cooling beam 601 includes a center plate 610 and one or more cooling channels 612 coupled to the center plate 610. Each center plate 610 has a first surface 614 and a second surface 616 opposite the first surface 614. One or more flanges can be coupled to the center plate 610 at the first end 602 and the second end 604 of each of the cooling beams 601. In the present illustrative configuration, the one or more flanges include a first flange 618 coupled to the center plate 610 at the first end 602 and a second flange 620 coupled to the center plate 610 at the second end 604. The first flange 618 extends away from the first surface 614 to a first end 622 and extends away from the second surface 616 to a second end 624. The first end 622 includes a lip 626 that depends from the first end 622 toward the second end 604 of the cooling beam 601. According to one aspect, the lip 626 can be configured to prevent the one or more battery cells 102 from deforming or crushing the one or more cooling channels 612 toward the first surface 614. The second end 624 of the first flange includes an upper surface 628 and a bottom surface 630. The bottom surface 630 can be configured to contact the upper end 110 of the prismatic can 104. The second flange 620 extends away from the first surface 614 to a first end 632 and extends away from the second surface 616 to a second end 634. The first end 632 includes an upper surface 636 and a bottom surface 638. The bottom surface 638 can be configured to contact the lower end 112 of the prismatic can 104. The second end 634 of the second flange 620 includes a lip 640 that depends from the second end 634 toward the first end 602 of the cooling beam 601. According to one aspect, the lip 640 can be configured to prevent the one or more battery cells 102 from deforming or crushing the one or more cooling channels 612 toward the second surface 616.

With reference to FIG. 11, the battery pack 700 is provided and includes the one or more battery cells 102 and one or more cooling beams 701. Each cooling beam 701 includes a first end 702 and a second end 704 spaced from the first end 702. Additionally, each cooling beam 701 includes a center plate 710 and one or more cooling channels 712 coupled to the center plate 710. Each center plate 710 has a first surface 714 and a second surface 716 opposite the first surface 714. One or more flanges can be coupled to the center plate 710 at the first end 702 and the second end 704 of each of the cooling beams 701. In the present illustrative configuration, the one or more flanges include a first flange 718 coupled to the center plate 710 at the first end 702 and a second flange 720 coupled to the center plate 710 at the second end 704. The first flange 718 extends away from the first surface 714 to a first end 722 and extends away from the second surface 716 to a second end 724. The first end 722 and the second end 724 of the first flange 718 can each include a lip 726 that depends from the first flange 718 toward the second end 704 of the cooling beam 701. The second flange 720 extends away from the first surface 714 to a first end 728 and extends away from the second surface 716 to a second end 730. The first end 728 and the second end 730 of the second flange 720 can each include a lip 732 that depends from the second flange 720 toward the first end 702 of the cooling beam 701. The lips 726, 732 of the first flange 718 and the second flange 720 can be desirable to prevent the battery cells 102 from deforming or crushing the one or more cooling channels 712.

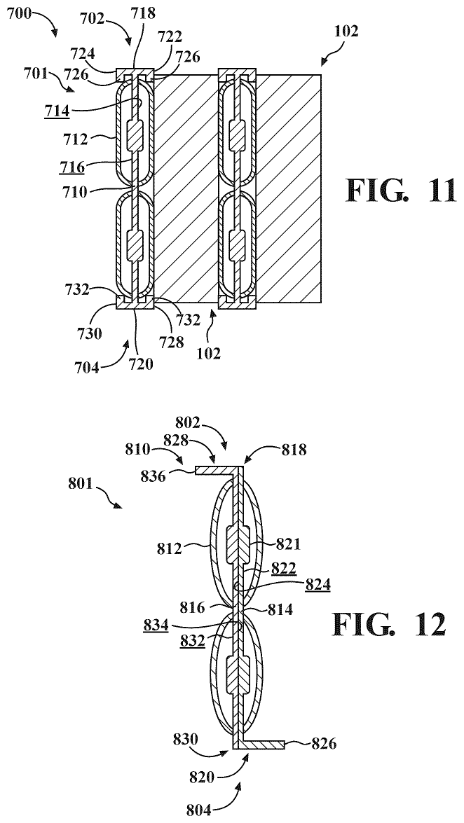

FIG. 12 provides an illustrative configuration of a cooling beam 801. This configuration is similar in many respects to the configurations of FIGS. 1-2, FIGS. 3-7, and FIGS. 8-11. Accordingly, the descriptions of the configurations are hereby incorporated into one another, and description of subject matter common to the configurations generally may not be repeated.

With reference to FIG. 12, the cooling beam 801 is provided and includes a first end 802 and a second end 804 spaced from the first end 802. The cooling beam 801 includes a center plate 810 and one or more cooling channels 812 coupled to the center plate 810. The center plate 810 includes a first half 814 and a second half 816 coupled to or otherwise attached to the first half 814. The first half 814 extends between a first end 818 and a second end 820 and includes a front surface 822 and a rear surface 824 opposite of the front surface 822. The front surface 822 of the first half 814 includes one or more projections 821 that extend away from the front surface 822. A first flange 826 can be coupled to the first half 814 at the second end 820 and extend away from the front surface 822. The second half 816 extends between a first end 828 and a second end 830 and includes a front surface 832 and a rear surface 834 opposite of the front surface 832. The front surface 832 of the second half 816 includes one or more projections 821 that extend away from the front surface 832. A second flange 836 can be coupled to the second half 816 at the first end 828 and extend away from the front surface 832. The one or more cooling channels 812 can be coupled to or otherwise attached to the front surfaces 822, 832 of the first half 814 and the second half 816. In assembly, the rear surface 824 of the first half 814 and the rear surface 834 of the second half 816 can be joined together so that the first ends 818, 828 meet at the first end 802 and the second ends 820, 830 meet at the second end 804.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A cooling beam having a first end and a second end spaced from the first end, comprising:
a center plate extending between the first end and the second end, and a first surface and a second surface opposite the first surface;
one or more cooling channels extending between the first end and the second end and coupled to the first surface and the second surface; and
a coolant pathway arranged between the center plate and the one or more cooling channels, the coolant pathway configured to carry a fluid between one or more inlets and one or more outlets.

2. The cooling beam of claim 1, wherein the center plate includes one or more projections coupled to and extending away from the first surface and the second surface toward the one or more cooling channels.

3. The cooling beam of claim 1, wherein the cooling channels include an inner surface and an outer surface opposite the inner surface.

4. The cooling beam of claim 3, wherein the inner surface and the outer surface include dimples that extend toward the center plate.

5. The cooling beam of claim 3, wherein the inner surface includes one or more concave portions and the outer surface includes one or more convex portions that correspond with the one or more concave portions.

6. The cooling beam of claim 5, wherein the convex portions each include a contact region that is substantially parallel to the center plate.

7. The cooling beam of claim 1, wherein the center plate includes a first half and a second half coupled to the first half.

8. The cooling beam of claim 1, wherein the cooling beam further includes a first region near the first end and a second region near the second end.

9. The cooling beam of claim 8, wherein the one or more inlets and the one or more outlets are arranged between the first region and the second region.

10. The cooling beam of claim 9, wherein the cooling pathway includes a first serpentine path that extends along the first region between the one or more inlets and the one or more outlets and a second serpentine path that extends along the second region between the one or more inlets and the one or more outlets.

11. A battery pack, comprising:
one or more battery cells, the one or more battery cells each comprising:
a prismatic can, comprising:
a first end and a second end spaced from the first end,
a third end and a fourth end spaced from the third end,
a first surface extending between the first, second, third, and fourth ends, and
a second surface extending between the first, second, third, and fourth ends, and spaced from the first surface; and
one or more cooling beams having a first end and a second end, comprising:
a center plate having a first surface and a second surface that each extend between the first end and the second end of the one or more cooling beams, the center plate having a first flange at the first end of the one or more cooling beams that extends away from the first surface and the second surface and a second flange at the second end of the one or more cooling beams that extends away from the first surface and the second surface, and
one or more cooling channels coupled to the first surface and the second surface of the center plate.

12. The battery pack of claim 11, wherein the first flange and the second flange include a notch that is configured to receive a portion of the prismatic can.

13. The battery pack of claim 11, wherein the first flange contacts the third end of one of the prismatic cans and the second flange contacts the fourth end of the same prismatic can.

14. The battery pack of claim 11, wherein the first flange includes a first lip that depends from the first flange toward the second end of one of the one or more cooling beams and the second flange includes a second lip that depends from the second flange toward the first end of one of the one or more cooling beams.

15. The battery pack of claim 14, wherein the first lip and the second lip each contact a portion of the one or more battery cells.

16. A vehicle, comprising:
a vehicle body;
a motor coupled to the vehicle body; and
a battery pack coupled to the vehicle body and communicatively coupled to the motor, the battery pack comprising:
one or more battery cells each having a prismatic can, and
one or more cooling beams each having a first end and a second end spaced from the first end, the one or more cooling beams being arranged between the one or more battery cells, the one or more cooling beams comprising:
a center plate having a first surface and a second surface that each extend between the first end of the one or more cooling beams and the second end of the one or more cooling beams, the center plate having a first flange at the first end that extends away from the first surface and the second surface and a second flange at the second end that extends away from the first surface and the second surface, and
one or more cooling channels coupled to the first surface and the second surface of the center plate.

17. The vehicle of claim 16, wherein the first flange and the second flange include a notch that is configured to receive a portion of the prismatic can.

18. The vehicle of claim 16, wherein the first flange and the second flange each contact one of the prismatic cans.

19. The vehicle of claim 16, wherein the first flange includes a first lip that depends from the first flange toward the second end of one of the one or more cooling beams and the second flange includes a second lip that depends from the second flange toward the first end of one of the one or more cooling beams.

20. The vehicle of claim 19, wherein the first lip and the second lip each contact a portion of the one or more battery cells.
